(19) United States
(12) Patent Application Publication
(10) Pub. No.: US 2020/0106859 A1
(43) Pub. Date: Apr. 2, 2020

(54) TRANSMISSION AND RECEPTION APPARATUS, TRANSMISSION AND RECEPTION SYSTEM, AND NON-TRANSITORY COMPUTER READABLE MEDIUM STORING PROGRAM

(71) Applicant: FUJI XEROX CO., LTD., Tokyo (JP)

(72) Inventors: Asahito SHIOYASU, Kanagawa (JP); Kenta NOMURA, Kanagawa (JP); Tomoki TANIHATA, Kanagawa (JP)

(73) Assignee: FUJI XEROX CO., LTD., Tokyo (JP)

(21) Appl. No.: 16/373,641

(22) Filed: Apr. 3, 2019

(30) Foreign Application Priority Data
Oct. 1, 2018 (JP) 2018-186632

(51) Int. Cl. H04L 29/08

(52) U.S. Cl. CPC H04L 67/34; H04W 84/12

(57) ABSTRACT

A transmission and reception apparatus includes a transmission unit that transmits data to a target machine in which a storage device is provided, a reception unit that receives data in the storage device that stores the data transmitted by the transmission unit, and a confirmation unit that confirms whether the data transmitted by the transmission unit and the data received by the reception unit coincide with each other.

### CROSS-REFERENCE TO RELATED APPLICATIONS

This application is based on and claims priority under 35 USC 119 from Japanese Patent Application No. 2018-186632 filed Oct. 1, 2018.

### BACKGROUND

### (i) Technical Field

The present invention relates to a transmission and reception apparatus, a transmission and reception system, and a non-transitory computer readable medium storing a program.

### (ii) Related Art

JP2016-197380A discloses a system including a plurality of units each of which is provided with a processing unit that is operated by means of firmware and a storage unit storing the firmware, the system including: an electric power control unit that controls supply of electric power to each of the plurality of units; an acquiring unit that acquires update data of firmware; a first specifying unit that specifies a unit to be updated from among the plurality of units based on the update data; a second specifying unit that specifies a unit, which needs to be supplied with electric power when firmware of the unit specified by the first specifying unit is updated, from among the plurality of units; and an update unit that updates firmware stored in a storage unit of the unit specified by the first specifying unit by using the update data. When the update unit updates the firmware, the electric power control unit supplies electric power to a unit, which is specified by the second specifying unit from among the plurality of units as a unit that needs to be supplied with electric power, and stops supply of electric power to the other units.

### SUMMARY

Aspects of non-limiting embodiments of the present disclosure relate to a transmission and reception apparatus, a transmission and reception system, and a non-transitory computer readable medium storing a program with which it is possible to reduce power consumption in comparison with a case where electric power is supplied to a display device of a target machine at the time of communication.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transmission and reception apparatus including a transmission unit that transmits data to a target machine in which a storage device is provided, a reception unit that receives data in the storage device that stores the data transmitted by the transmission unit, and a confirmation unit that confirms whether the data transmitted by the transmission unit and the data received by the reception unit coincide with each other.

Note that, WiFi (registered trademark) is one of wireless communication methods established based on the IEEE 802.11 standard.

### BRIEF DESCRIPTION OF THE DRAWINGS

Exemplary embodiment(s) of the present invention will be described in detail based on the following figures, wherein:

FIG. 1 is a schematic view illustrating the entire transmission and reception system according to an exemplary embodiment of the present invention;

FIG. 2 is a block diagram illustrating a hardware configuration of a terminal apparatus used in the exemplary embodiment of the present invention;

FIG. 3 is a block diagram illustrating a hardware configuration of a target machine used in the exemplary embodiment of the present invention;

FIG. 4 is a sequence diagram illustrating an operation flow of the terminal apparatus and target machine in the exemplary embodiment of the present invention;

FIG. 5 is a timing chart illustrating a temporal operation flow of the terminal apparatus and target machine in the exemplary embodiment of the present invention; and

FIG. 6 is a timing chart illustrating a temporal operation flow of a terminal apparatus and a target machine in a comparative example.

### DETAILED DESCRIPTION

Next, an exemplary embodiment of the present invention will be described in detail with reference to drawings.

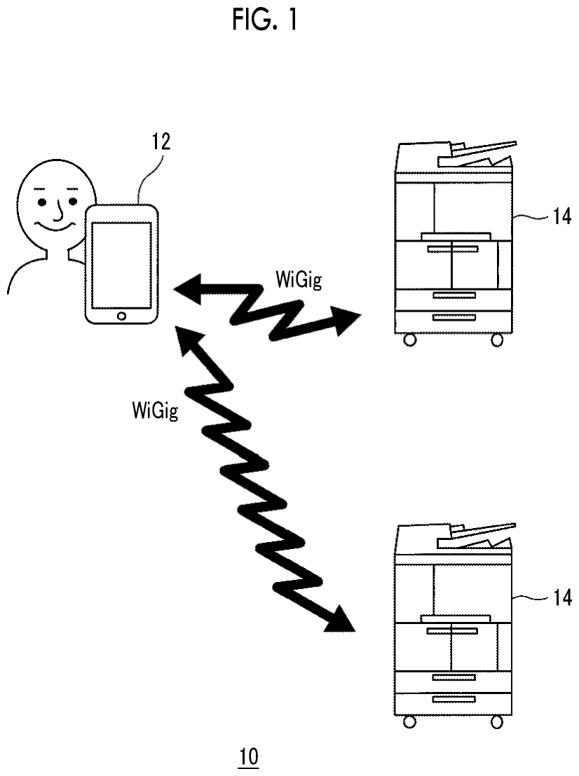

FIG. 1 illustrates a transmission and reception system according to the exemplary embodiment of the present invention.

A transmission and reception system 10 is a system in which data is transmitted and received between a terminal apparatus 12 and, for example, a plurality of target machines 14 that can communicate with the terminal apparatus 12 in a wireless manner. The terminal apparatus 12 is, for example, a smart phone, a personal computer, or the like. The target machines 14 are, for example, image forming apparatuses and more specifically, the target machines are so-called multifunction machines having a printing function, a facsimile function, a copying function, a scanning function, and the like.

In the exemplary embodiment, data is downloaded to the target machines 14 from the terminal apparatus 12. Although the kind of data is not particularly limited, an example in which firmware is downloaded to the target machines 14 will be described in the exemplary embodiment.

Here, firmware is a program for controlling the operation of the target machines 14 and there is a case where the firmware is downloaded to provide an update for the purpose of improvement of the functions of the target machines 14, troubleshooting, or the like. The firmware to be downloaded will be referred to as download data.

For communication between the terminal apparatus 12 and the target machines 14, for example, WiGig (Wireless Gigabit (registered trademark)) is used. WiGig is one of wireless communication methods standardized as IEEE 802.11ad. WiGig is higher in directivity than WiFi and is faster than WiFi.

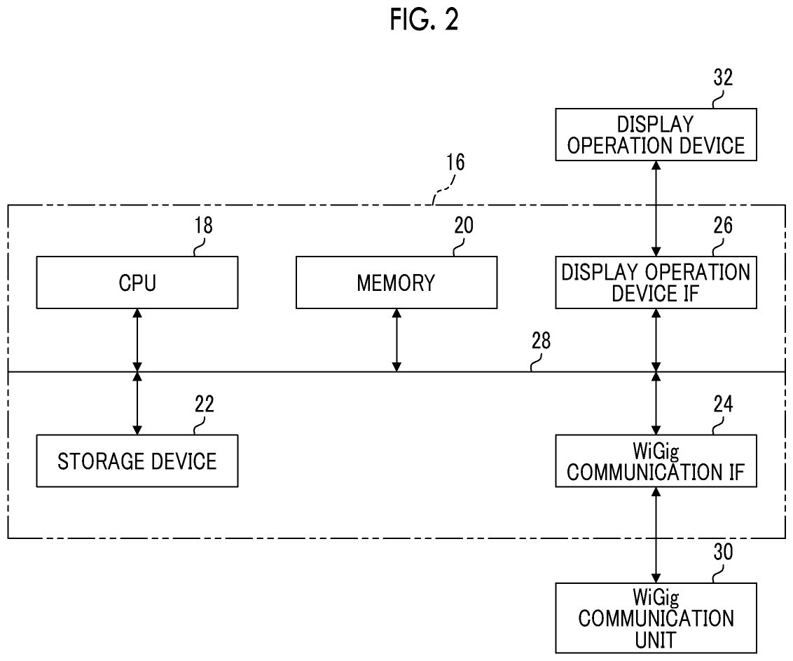

FIG. 2 illustrates a hardware configuration of the terminal apparatus 12.

The terminal apparatus 12 includes a control main body unit 16. The control main body unit 16 includes a CPU 18, a memory 20, a storage device 22, a WiGig communication interface 24, and a display operation device interface 26 and the CPU 18, the memory 20, the storage device 22, the WiGig communication interface 24, and the display operation device interface 26 are connected to each other via a bus 28.

The CPU 18 executes a predetermined process based on a control program stored in the memory 20. The memory 20 is a volatile memory such as a random access memory (RAM). The storage device 22 is configured of a non-volatile memory such as a flash memory, a hard disk, or the like and necessary software or data is stored therein. Here, the download data to be installed in the target machines 14 is stored in the storage device 22. A WiGig communication unit 30 is connected to the WiGig communication interface 24 such that WiGig communication can be performed. A display operation device 32 is connected to the display operation device interface 26. The display operation device 32 is configured by combining, for example, a touch panel and a liquid crystal display.

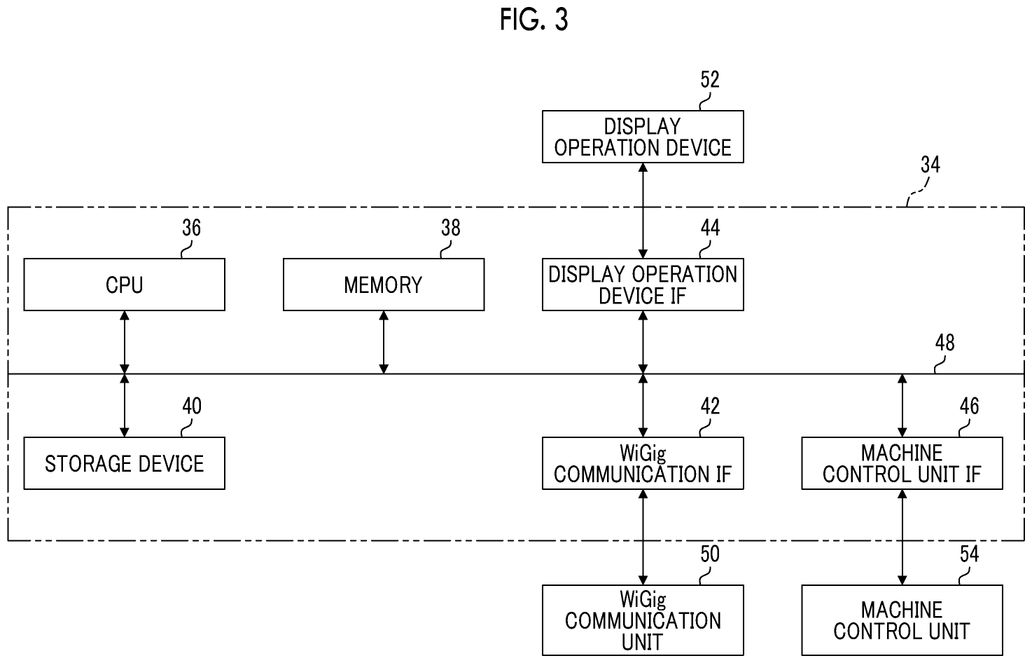

FIG. 3 illustrates a hardware configuration of each of the target machines 14.

Each of the target machines 14 includes a control main body unit 34. The control main body unit 34 includes a CPU 36, a memory 38, a storage device 40, a WiGig communication interface 42, a display operation device interface 44, and a machine control unit interface 46 and the CPU 36, the memory 38, the storage device 40, the WiGig communication interface 42, the display operation device interface 44, and the machine control unit interface 46 are connected to each other via a bus 48.

The CPU 36 executes a predetermined process based on a control program stored in the memory 38. The memory 38 is a volatile memory such as a RAM. Data is temporarily stored in the memory 38. The storage device 40 is configured of a non-volatile memory such as a flash memory, a hard disk, or the like and necessary software or data is stored therein. A WiGig communication unit 50 is connected to the WiGig communication interface 42 such that WiGig communication can be performed. A display operation device 52 is connected to the display operation device interface 44. The display operation device 52 is configured by combining, for example, a touch panel and a liquid crystal display. A machine control unit 54 is connected to the machine control unit interface 46. The machine control unit 54 controls machines of the target machine 14, for example, each machine of an image forming unit.

Note that, the CPU 18 of the terminal apparatus 12 is higher in clock rate and in processing speed than, for example, the CPU 36 of each of the target machines 14.

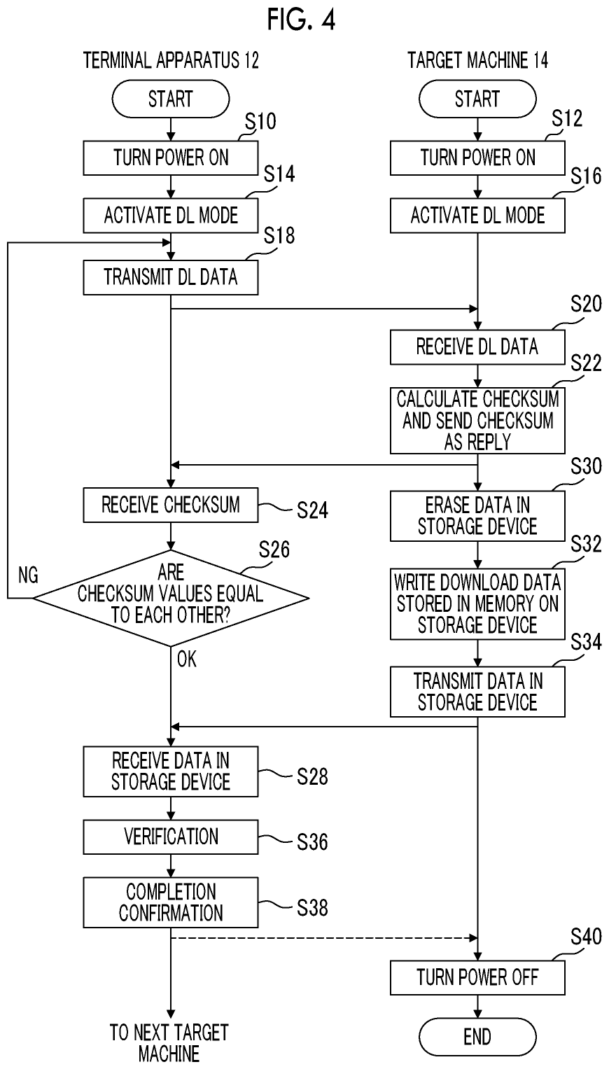

FIG. 4 is a sequence diagram illustrating an operation flow of the terminal apparatus 12 and the target machines 14.

First, in Step S10 and Step S12, the terminal apparatus 12 and the target machine 14 are turned on. However, in the target machine 14, power supply to the display operation device 52 and the machine control unit 54 is cut off and power is supplied only to the control main body unit 34 and the WiGig communication unit 50. Next, in Steps S14 and S16, the terminal apparatus 12 and the target machine 14 activate a download mode (DL mode). Here, activating the download mode means entering a state where the download data can be transmitted and received.

Next, in Step S18, the terminal apparatus 12 transmits the download data from the WiGig communication unit 30 to the target machines 14 by WiGig. In Step S20, the target machine 14 receives the download data through the WiGig communication unit 50 by WiGig.

Next, in Step S22, the target machine 14 calculates a checksum value and sends the calculated checksum value to the terminal apparatus 12 as a reply through the WiGig communication unit 50 by WiGig. The checksum is transmission confirmation data obtained by dividing data to be transmitted into blocks, encoding the blocks, and adding up the values thereof. Adding up is performed in the same manner on a reception side as well and when the value obtained through the adding up is equal to a received value, it is determined that data has been correctly transmitted.

In Step S24, the terminal apparatus 12 receives the checksum value sent as a reply through the WiGig communication unit 30 by WiGig. Next, in Step S26, the terminal apparatus 12 determines whether the checksum value that is calculated by the target machine 14 and a checksum value that is calculated from the download data stored in the memory 20 or the storage device 22 of the terminal apparatus 12 are equal to each other or not. In a case where it is determined that the checksum value is not correct in Step S22, the process returns to Step S18 and the download data is transmitted to the target machine 14 again. Meanwhile, in a case where it is determined that the checksum value is correct in Step S24, the process proceeds to Step S28.

Meanwhile, after the target machine 14 calculates the checksum value of the download data and sends the calculated checksum value to the terminal apparatus 12 as a reply in Step S22, the target machine 14 proceeds to Step S30. In Step S30, data stored in the storage device 40 is erased. Next, in Step S32, the target machine 14 writes the download data stored in the memory 38 on the storage device 40. Note that, an erasing process in Step S30 is needed in a case where the storage device 40 is a flash memory. However, in a case where the storage device 40 is a hard disk, the erasing process in Step S30 is not needed although a writing process in Step S32 is performed.

Next, in Step S34, the target machine 14 transmits the data stored in the storage device 40 to the terminal apparatus 12 through the WiGig communication unit 50 by WiGig. When the terminal apparatus 12 receives the data in the storage device 40 through the WiGig communication unit 30 by WiGig in Step S28, the terminal apparatus 12 performs a verifying process in Step S36. The verifying process is a process of confirming whether data is stored in the storage device 40 without an error or not. Here, the received data in the storage device 40 is compared with the download data that is stored in the memory 20 or the storage device 22 before the terminal apparatus 12 transmits the download data.

Next, in Step S38, the terminal apparatus 12 confirms completion of the verifying process and a downloading process with respect to the target machine 14 is terminated. The completion of the verifying process may be displayed on the display operation device 32 of the terminal apparatus 12 and a user may confirm the completion of the verifying process. A configuration in which Information about confirmation of the completion of the verifying process is transmitted to the target machine 14 and the target machine 14 is turned off in Step S40 may be adopted and a configuration in which the Information about completion confirmation is not transmitted and the user turns the target machine 14 off may also be adopted. In a case where power is supplied to the target machine 14 next time, the target machine 14 is initialized and the download data is reflected. The terminal apparatus 12 starts a downloading process for the next target machine when the process in Step S38 is terminated.

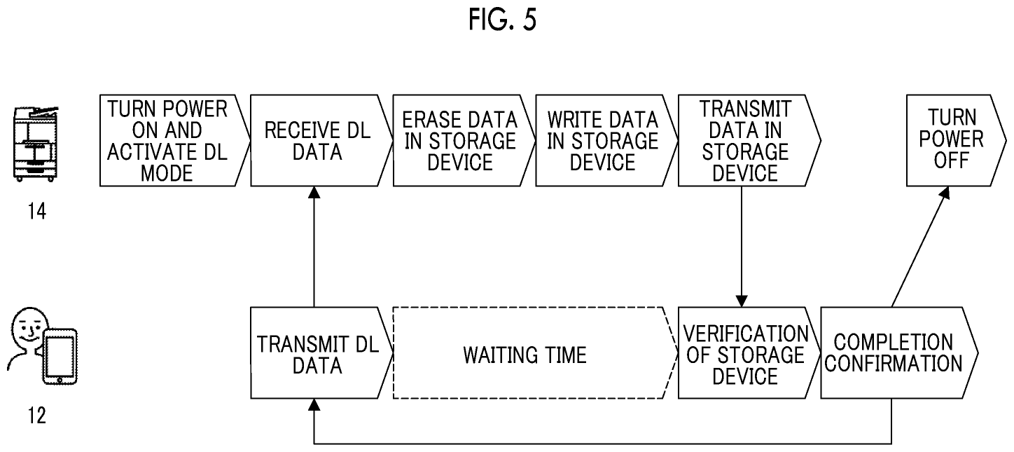

FIG. 5 illustrates a temporal operation flow of the terminal apparatus 12 and the target machine 14 according to the exemplary embodiment of the present invention.

The terminal apparatus 12 receives the data stored in the storage device from the target machine 14 and the terminal apparatus 12 performs the verifying process. Waiting time of the terminal apparatus 12 is a time from when transmission of the download data to the target machine 14 is complete to when the verifying process is started. After receiving the data stored in the storage device from the target machine 14, the terminal apparatus 12 may execute a downloading process for another target machine in parallel.

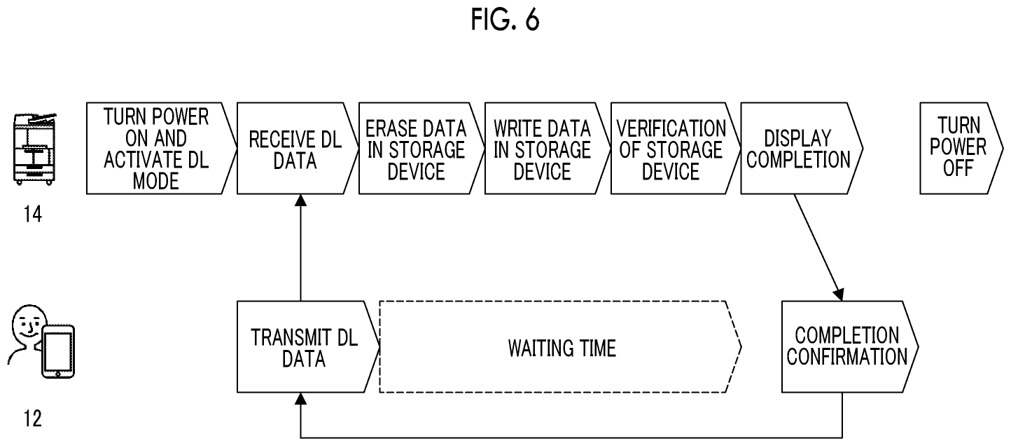

Meanwhile, FIG. 6 illustrates a temporal operation flow of the terminal apparatus 12 and the target machine 14 according to a comparative example.

In the comparative example, the target machine 14 performs the verifying process after erasing data in the storage device and writing the download data in the storage device. Accordingly, in addition to a time taken for the target machine 14 to erase the data in the storage device and to write the download data in the storage device, a time taken for the verifying process is added to waiting time of the terminal apparatus 12. Here, in a case where the processing speed of the CPU of the terminal apparatus 12 is higher than the processing speed of the CPU of the target machine 14, the overall processing speed becomes higher in comparison with the comparative example when the terminal apparatus 12 performs the verifying process.

Note that, in the exemplary embodiment, the target machines are image forming apparatuses. However, the present invention is not limited thereto and a robot or an electronic product may be the target machine, for example. In addition, the location of the target machine may be a factory, a ship on a transportation route, a mass installation place, or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transmission and reception apparatus comprising:
a transmission unit that transmits data to a target machine in which a storage device is provided;
a reception unit that receives data in the storage device that stores the data transmitted by the transmission unit; and
a confirmation unit that confirms whether the data transmitted by the transmission unit and the data received by the reception unit coincide with each other.

2. The transmission and reception apparatus according to claim 1,
wherein the transmission unit and the reception unit perform transmission and reception by a WiGig communication method standardized as IEEE 802.11ad.

3. The transmission and reception apparatus according to claim 1, further comprising:
a display device on which information is displayed,
wherein, in a case where confirmation performed by the confirmation unit is complete, information about confirmation completion is displayed on the display device.

4. The transmission and reception apparatus according to claim 2, further comprising:
a display device on which information is displayed,
wherein information about confirmation completion is displayed on the display device in a case where confirmation performed by the confirmation unit is complete.

5. A transmission and reception system comprising:
a terminal apparatus; and
a target machine that includes a storage device storing data;
wherein the terminal apparatus includes
a transmission unit that transmits data to the target machine;
a reception unit that receives data in the storage device that stores the data transmitted by the transmission unit; and
a confirmation unit that confirms whether the data transmitted by the transmission unit and the data received by the reception unit coincide with each other.

6. The transmission and reception system according to claim 5,
wherein the terminal apparatus further includes a display device on which information is displayed and information about confirmation completion is displayed on the display device in a case where confirmation performed by the confirmation unit is complete.

7. The transmission and reception system according to claim 5,
wherein the target machine includes a display device on which information is displayed and power supply to the display device is cut off in a case where data is transmitted and received between the terminal apparatus and the target machine.

8. The transmission and reception system according to claim 6,
wherein the target machine includes a display device on which information is displayed and power supply to the display device is cut off in a case where data is transmitted and received between the terminal apparatus and the target machine.

9. A non-transitory computer readable medium storing a program causing a computer to execute a process, the process comprising:
transmitting data to a target machine in which a storage device is provided;
receiving data in the storage device that stores the transmitted data; and
confirming whether the transmitted data and the received data coincide with each other.
